(19) United States
(12) Patent Application Publication
(10) Pub. No.: US 2008/0208982 A1
(43) Pub. Date: Aug. 28, 2008

(54) METHOD AND SYSTEM FOR PROVIDING STATUS INFORMATION RELATING TO A RELATION BETWEEN A PLURALITY OF PARTICIPANTS

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/680,273

(22) Filed: Feb. 28, 2007

(51) Int. Cl. G06F 15/16; G06F 13/00

(52) U.S. Cl. 709/206; 719/317

(57) ABSTRACT

Methods and systems are described for providing status information relating to a relation between a plurality of participants. One method includes receiving a first message from an agent associated with a relation principal for a relation between a plurality of participants, the message including relation status information of the relation. A relation tuple associated with the relation principal for the relation is provided. The relation tuple includes a party element having information identifying at least one of the plurality of participants in the relation and a status element having a status of the relation. In response to providing the relation tuple, a notification message including at least a portion of the received relation status information is generated.

### BACKGROUND

In today's presence systems, presence services store data entities, known as tuples that are associated with presence clients that can represent users or devices. A tuple, in its broadest sense, is a data object containing one or more elements. If a tuple contains a status element, it is referred to as a presence tuple and the information stored in the status element is referred to as presence information. Typically, presence information is limited to information about the “owner” of the tuple, and in particular, to information about the owner's availability or status. The owner can publish its presence information as well as other information to its presence tuple and the published information can be presented to a watcher, which is a presence entity that receives presence information from a presence service on behalf of a presence client.

One problem with current presence tuples is that the status information is typically a single value, such as “available,” “online,” “busy,” or “away.” An owner's status, however, can seldom be accurately described by a single value. For example, a user or device may be “available” for one set of activities, but not available for another set. Similarly, the user may be “available” with respect to one set of people, but not available to another. In many cases, the user's status depends on one or more relations in which the user is engaged. Nonetheless, current presence tuples do not take into account relations in which the user is currently involved and that affect the user's status. For example, an existing presence tuple can provide status information that indicates that the user is “busy,” but does not indicate with whom or with what the user is “busy.” Thus, the status information can be misleading when the user is “busy” talking to a friend, but “available” to take telephone calls from coworkers.

To address this shortcoming, a multi-valued status format can be implemented that provides multiple status elements for a plurality of activities. This, however, can quickly become a problem when the user engages in several relations simultaneously with several different participants and the presence tuple becomes large and unmanageable. Moreover, because other participants are involved, duplicate information can be introduced across multiple tuples associated with the other participants.

Accordingly, there exists a need for methods, systems, and computer program products for providing status information relating to a relation between a plurality of participants.

### SUMMARY

Methods and systems are described for providing status information relating to a relation between a plurality of participants. One method includes receiving a first message from an agent associated with a relation principal for a relation between a plurality of participants, the message including relation status information of the relation. A relation tuple associated with the relation principal for the relation is provided. The relation tuple includes a party element having information identifying at least one of the plurality of participants in the relation and a status element having a status of the relation. In response to providing the relation tuple, a notification message including at least a portion of the received relation status information is generated.

In another aspect of the subject matter disclosed herein, another method for providing status information relating to a relation between a plurality of participants includes receiving relation status information from a relation service managing a relation between a plurality of participants and providing a relation tuple that includes the relation status information. The relation tuple comprises a party element having information identifying at least one of the plurality of participants in the relation and a status element having a status of the relation. A message including the relation tuple is generated and sent to a status service via a network such that a watcher component watching at least one of the relation tuple and a status tuple of a participant of the plurality of participants receives at least a portion of the relation status information included in the relation tuple.

In another aspect of the subject matter disclosed herein, a system for providing status information relating to a relation between a plurality of participants includes a relation status service component configured for receiving a first message from an agent associated with a relation principal for a relation between a plurality of participants, the message including relation status information of the relation, and for providing a relation tuple associated with the relation principal for the relation, the relation tuple including a party element having information identifying at least one of the plurality of participants in the relation and a status element having a status of the relation. The system also includes a notification handler component configured for generating a notification message including at least a portion of the received relation status information in response to providing the relation tuple.

In another aspect of the subject matter disclosed herein, another system for providing status information relating to a relation between a plurality of participants includes a relation service configured for managing a relation between a plurality of participants and for providing a relation principal associated with the relation, and a relation status client component associated with the relation principal. The relation status client component is configured for receiving relation status information from the relation service, for providing a relation tuple that includes relation status information, the relation tuple comprising a party element having information identifying at least one of the plurality of participants in the relation and a status element having a status of the relation, for generating a message including the relation tuple, and for sending the message to a status service via a network such that a watcher component watching at least one of the relation tuple and a status tuple of a participant of the plurality of participants receives at least a portion of relation status information included in the relation tuple.

In another aspect of the subject matter disclosed herein, a computer readable medium containing a computer program, executable by a machine, for providing status information relating to a relation between a plurality of participants is disclosed. The computer program comprises executable instructions for receiving a first message from an agent associated with a relation principal for a relation between a plurality of participants, the message including relation status information of the relation, providing a relation tuple associated with the relation principal for the relation, the relation tuple including a party element having information identifying at least one of the plurality of participants in the relation and a status element having a status of the relation, and generating a notification message including at least a portion of the received relation status information in response to providing the relation tuple.

In another aspect of the subject matter disclosed herein, a computer readable medium containing a computer program, executable by a machine, executable instructions for receiving relation status information from a relation service managing a relation between a plurality of participants, providing a relation tuple that includes the relation status information, the relation tuple comprising a party element having information identifying at least one of the plurality of participants in the relation and a status element having a status of the relation, generating a message including the relation tuple, and sending the message to a status service via a network such that a watcher component watching at least one of the relation tuple and a status tuple of a participant of the plurality of participants receives at least a portion of the relation status information included in the relation tuple.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for providing status information relating to a relation according to an exemplary embodiment;

FIG. 2 is a block diagram illustrating an exemplary user device according to an exemplary embodiment;

FIG. 3 is a block diagram illustrating an exemplary relation server according to an exemplary embodiment;

FIG. 4 is a block diagram illustrating an exemplary status server according to an exemplary embodiment;

FIG. 5 is a flowchart illustrating a method of providing status information relating to a relation according to an exemplary embodiment;

FIG. 6 illustrates an exemplary tuple structure supporting relation status information according to an exemplary embodiment;

FIG. 7 is a flowchart illustrating a method for providing status information relating to a relation according to another exemplary embodiment; and

FIG. 8 is a message flow diagram showing a process of providing status information relating to a relation between a plurality of participants according to one embodiment.

### DETAILED DESCRIPTION

Methods, systems, and computer program products for providing status information relating to a relation between a plurality of participants are disclosed. Well known presence protocols, such as XMPP-IM, SIP SIMPLE, and RVP, are used by presence services, and Jabber Software Foundation's pub/sub protocol as specified in Jabber Enhancement Proposal (JEP) JEP0060: Publish-Subscribe.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al., titled “Extensible Messaging and Presence Protocol (XMPP): Instant Messaging and Presence,” each of which are published and owned by the Internet Society and incorporated here in their entirety by reference.

Generally speaking, one or more publish/subscribe (“pub/sub”) servers are used to provide pub/sub services. The function of a pub/sub server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

The presence model of RFC 2778 describes two types of watchers, referred to as “subscribers” and “fetchers.” A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, aspects of an exemplary embodiment described here can employ a presence protocol as the pub/sub communication protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

According to pub/sub communication protocols, a pub/sub service stores and organizes information provided by a publisher and by a subscriber in data entities referred to as tuples. As stated above, a tuple, in its broadest sense, is a data object containing one or more elements. If a tuple contains a status element it is referred to as a presence tuple (RFC 2778) and the information stored in the status element is referred to as presence information. A pub/sub service which processes presence tuples is referred to as a presence service. In addition to containing a status element, a presence tuple can include any other content.

A tuple can represent any element used to store the published information associated with a publisher or principal. The published information may include general contact information of the publisher, such as name, telephone number, email address, postal address, an IP addresses or URLs associated with the publisher, and the like, as well as other data or content. As used here, a tuple can also be a representation that maps field names to certain values to indicate that an entity or object (e.g., the principal) includes certain components, information, and/or perhaps has certain properties.

As stated above, existing presence tuples typically include a status element that stores presence information of principals, such as users or devices. Nonetheless, because presence information typically focuses on the principal, without regard to the relations in which the principal is engaged, presence information alone can be misleading and an inaccurate indicator of the principal's true status.

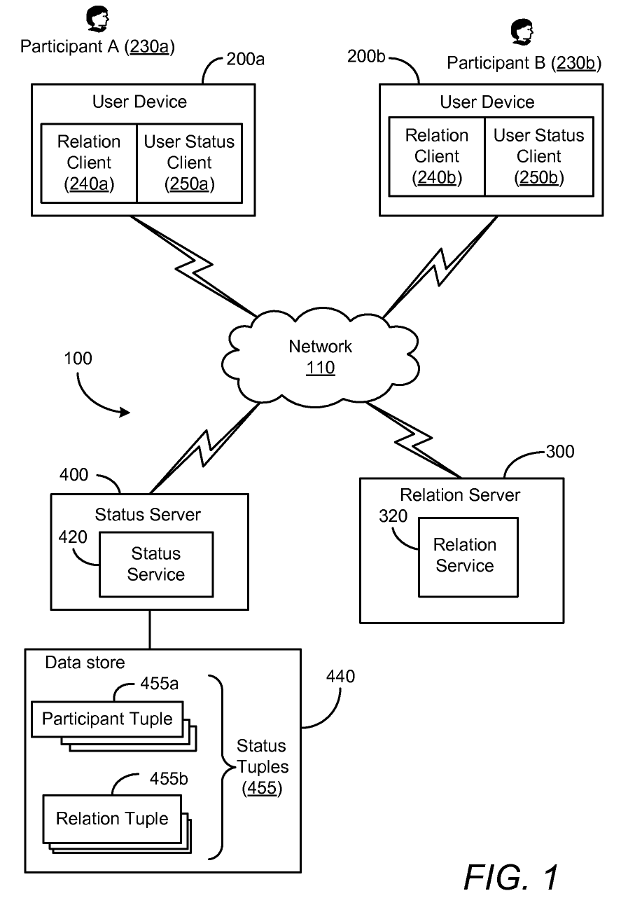

Accordingly, in one aspect, a method and system for providing status information relating to a relation between a plurality of participants are described. FIG. 1 is a block diagram illustrating an exemplary system according to one embodiment. The system 100 includes a plurality of user devices 200a, 200b communicatively coupled to a relation server 300 and to a status server 400 by a network 110. The network 110 may be a Local Area Network (LAN) and/or a Wide Area Network (WAN) including the Internet.

In one embodiment, each user device 200a, 200b is associated with a user/participant 230a, 230b, and includes a relation client 240a, 240b and a user status client 250a, 250b. Each user device 200a provides (not shown) a processor, operating system or control program, a network subsystem, input/output subsystems, and memory subsystems in order to provide an operating environment allowing the relation client 240a and the user status client 250a to operate.

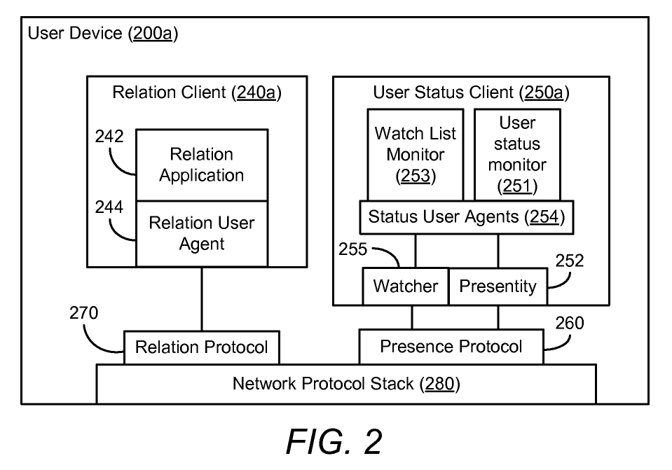

FIG. 2 is a block diagram showing an exemplary user device 200a according to one embodiment. Referring to FIG. 1 and FIG. 2, the participant 230a can use the user status client 250a to publish and receive status information to and from a status service 420 in the status server 400. In one embodiment, the status service 420 stores and manages status tuples 455 in a data store 440. The status tuples 455 can include at least one of participant tuples 455a associated with participants 230a, 230b and relation tuples 455b associated with relations. In one embodiment, the status service 420 can be a presence service and the user status client 250a can be a presence client. In such an embodiment, the participant 230a can be a principal although the principal can also be a software component, a hardware component, or a system comprising at least one of a human user, a software component, and a hardware component of the user device 200a. In this embodiment, the user status client 250a can include a user status monitor 251 that detects changes in the principal's status and a watch list monitor component 253 that uses a watcher component 255 to watch for status changes of other principals, e.g., 230b.

In one embodiment, the principal 230a is associated with a participant tuple 455a stored in the data store 440 managed by the status service 420. When the status monitor component 251 detects a change in the principal's status information, a presentity component 252 associated with the principal 230a generates a message including a status tuple based on the changed status information. The message is transmitted to the status service 420 via the network 110. When the message is received, the status service 420 creates and/or updates the associated participant tuple 455a stored in the data store 440 and sends notification messages to any watcher components 255 that are to be notified of the status information update. In one embodiment, the participant tuple 455a associated with an object, such as a user, a component or a device, can be a standard presence tuple.

According to one embodiment, the user device 200a also includes a relation client 240a that is used to establish a relation between the participant 230a and another participant 230b via a relation service 320 in the relation server 300. In one embodiment, the relation service 320 can be any communication or transaction service that supports and manages a relation between a plurality of participants 230a, 230b. For example, the relation service 320 can be a messaging service, such as an instant messaging (IM) service or a voice over IP (VoIP) service, a secure transaction service, or a file transfer proxy. Accordingly, the relation clients 240a, 240b can be IM clients, VoIP clients, transaction clients and the like. In one embodiment, the relation client 240a includes a relation application 242 that uses a relation user agent 244 to send and receive messages to and from the relation service 320 using a relation protocol 270 and network protocol stack component 280.

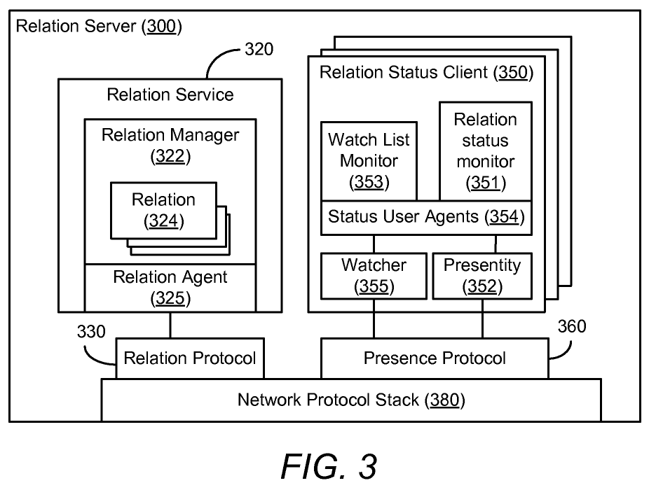

FIG. 3 is a block diagram illustrating an exemplary relation server 300 that includes a relation service 320 according to one embodiment. The relation service 320 includes a relation manager 322 that is configured to manage a relation 324 between a plurality of participants 230a, 230b via their respective user devices 200a, 200b. For example, suppose the relation service 320 is an IM service 320 that receives IM messages via the network 110, for example, from the user devices 200a, 200b. The IM (relation) service 320 receives an IM message from a user device, e.g., 200a, using an IM protocol processed by an IM (relation) protocol layer 330 interoperating with a network protocol stack component 380 of the operating environment of the server 300. The IM message is received by a relation agent 325, e.g., an IM agent, which determines whether an IM message includes a session ID.

If a session ID is not detected, the IM agent 325 determines a source address of the sender of the message and a destination address associated with a receiver of the message. The IM agent 325 passes the source and destination addresses to the relation manager 322, e.g., an IM session manager, for establishing a session and returning an associated session ID. The IM agent 325 sends the message using the destination address to a recipient associated with the destination address using the IM protocol layer 330 and the network protocol stack component 380 over the network 110.

If a session ID is detected, IM agent 325 provides the session ID to the IM session manager 322, and in some embodiments provides activity information based on the received message along with the session ID. The IM session manager 322 locates session information associated with the session ID, and based on the session information, the IM session manager 322 allows the IM agent 325 to send the message to a recipient participating in the session, or provides an error indication to the IM agent 325 for processing.

According to one embodiment, when the relation manager 322 establishes a relation 324 between the plurality of participants 230a, 230b, it also generates an instance of a relation status client 350 for the relation 324 such that the relation 324 becomes a relation principal. In this description, the relation and the relation principal are interchangeable. In an exemplary embodiment, the relation principal 324 can use the relation status client 350 to publish relation status information relating to the relation to a relation tuple 455b associated with the relation principal 324 and stored in the data store 440 managed by the status service 420. According to one embodiment, relation tuples 455b can be affected by publish, subscribe, and notify commands. By providing and supporting relation tuples 455b, relation specific information can be maintained and updated in substantially real-time.

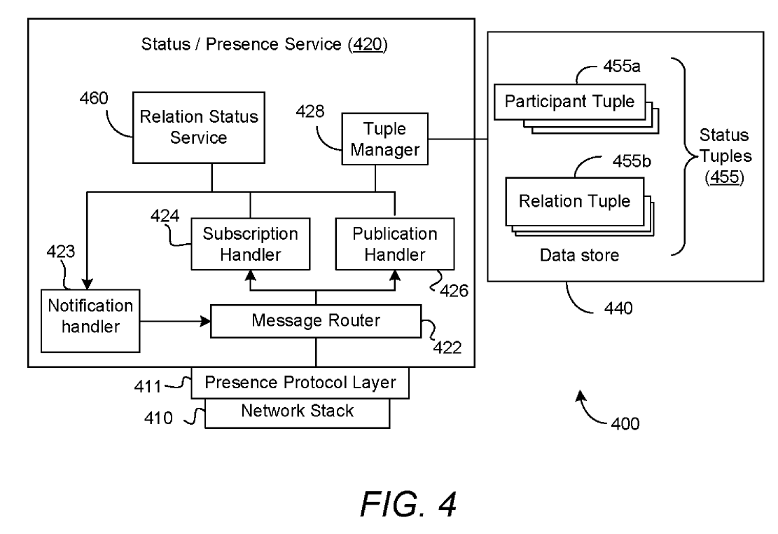

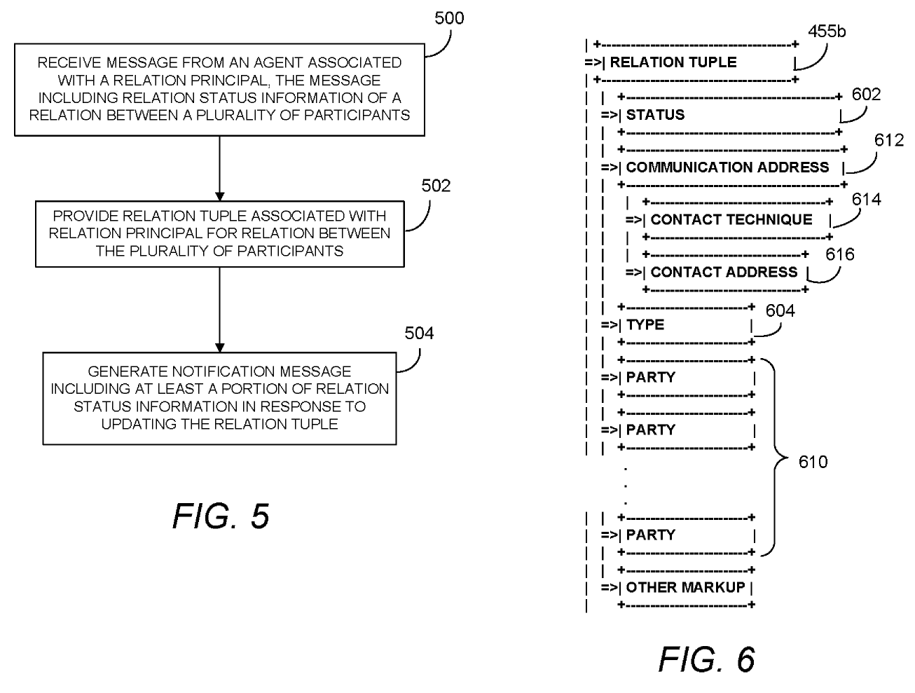

FIG. 4 is a block diagram illustrating an exemplary status server 400 that includes a status service 420 implemented as a presence service according to one embodiment, and FIG. 5 is a flowchart of an exemplary method for providing status information relating to a relation between a plurality of participants from a perspective of the status service 420 according to one embodiment. Referring to FIG. 4 and FIG. 5, the method begins when the status service 420 receives a first message from an agent associated with a relation principal 324 for a relation between a plurality of participants 230a, 230b (block 500). In an exemplary embodiment, the message includes relation status information relating to the relation 324. For example, the relation status information can include information describing the status or state of the relation 324 and information identifying at least one of the plurality of participants 230a, 230b.

In one embodiment where the status service is a presence service 420, the agent associated with the relation principal 324 can be a relation presentity 352 in the relation status client 350 associated with the relation principal 324 (FIG. 3). The first message from the relation presentity 352 is received by the status/presence service 420 via a network stack 410, which routes the message to a presence protocol layer 411. The presence protocol layer 411 then passes the message to a listening message router 422 of the status/presence service 420. The message router 422 determines that the message is a publish command and, as a result, passes the message content to a publication handler 426. The publication handler 426 determines that the message includes relation status information and passes the message content to a relation status service 460.

According to an exemplary embodiment, the relation status service component 460 is configured to receive, store, and manage the relation status information received from a relation status client 350. While shown as a separate component in FIG. 4, the relation status service component 460 can be embedded in the publication handler 426 or it can be a separate service application coupled to the presence service 420 via an application programming interface (not shown). In another embodiment, the relation status service component 460 can be hosted on another server.

In one embodiment, the relation status service component 460 provides a relation tuple 455b associated with the relation principal 324 for the relation (block 502). The relation 324 represented by the relation tuple 455b can be persistent, such as a relation between a manager and an employee, or a relation between a mother and a son. In another embodiment, the relation 324 can be temporary, such as a meeting, a phone call, a purchase order, or a financial transaction. As such, relation tuples 455b associated with temporary relations 324 can also be temporary. That is, such relation tuples 455b can be created dynamically as relations come into existence, and can be removed when the corresponding relations end.

In one embodiment, the relation tuple 455b is a structured data entity including a party element having information identifying at least one of the plurality of participants in the relation 324 and a status element having a status of the relation 324. FIG. 6 illustrates an exemplary relation tuple 455b according to one embodiment. In the relation tuple 455b, the status element 602 includes information reflecting a status or state of the relation 324. For example, when the relation 324 is a meeting, the meeting status can be “scheduled,” “active,” or “complete.” In another example, when the relation 324 is a transaction session, the status element 602 can include a value such as “setup requested,” “service located,” “setup request pending,” “request accepted,” “request pending,” and “confirmation requested,” “confirmation denied,” “request aborted,” request rolled-back,” or “request processing terminated.” In an embodiment, the status of a relation 324, whether provided as a single valued element or a multi-valued element or elements, is not simply an aggregation or collection of the status of the participants 230a, 230b in the relation 324. Accordingly, relation tuples 455b differ significantly from other existing presence tuples, such as group tuples.

In one embodiment, the relation tuple 455b also includes a plurality of party elements 610. Each party element 610 is provided for including information that identifies a participant 230a, 230b engaged in the relation. In one embodiment, the identifying information can identify a participant tuple 455a of the participant 230a, 230b.

In another embodiment, the relation tuple 455b can include additional optional information, such as a type element 604 for specifying a type of a relation 324. A relation type can be associated with a schema that defines characteristics of the relation tuple 455b, such as its content, e.g., status information, cardinality, directionality, and lifetime. The relation tuple 455b can also include a communication address element 612 that has a contact element 614 for identifying a technique for using an address provided in a contact address element 616. The relation tuple 455b is extendible as indicated by the other markup element allowing further extensions to be added to the relation tuple 455b format.

Referring again to FIG. 4, in an exemplary embodiment, the relation status service 460 is configured to store the relation tuple 455b in the data store 440. For example, the relation status service 460 can use a tuple manager 428 that manages the status tuples 455, including participant tuples 455a and relation tuples 455b, to store the relation tuple 455b in the data store 440. Alternatively, in another embodiment, the relation tuples 455b can be stored separately from the participant tuples 455a in another data store (not shown) and managed directly by the relation status service 460. In yet another embodiment, the status tuples 455 in the data store 440 can all be relation tuples 455b such that the status service 420 is dedicated to relation principals and status information relating to the relations.

In addition to storing the relation tuple 455b, the relation status service 460 can, in one embodiment, direct a subscription handler component 424 to create a subscription list for the relation tuple 455b and to place on the list the plurality of participants identified in the relation tuple 455b. In this manner, each of the plurality of participants can be automatically subscribed to receive updates to the relation tuple 455b when new relation status information is received from the agent associated with the relation principal 324.

According to one embodiment, when the relation tuple 455b is provided, the participant tuple 455a of at least one of the plurality of participants 230a, 230b can also be automatically updated based on the received relation status information. For example, the information identifying the participants 230a, 230b can include, in one embodiment, identifiers of the participant tuples 455a associated with the participants 230a, 230b. The relation status service 460 can then use the identifiers to update at least one participant tuple 455a belonging to a participant in the relation 324. In another embodiment, a policy tuple (not shown) can be implemented that specifies a condition, which when satisfied as a result of an update to the relation tuple 455b, performs an action resulting in the updating of the at least one participant tuples 455a. Such policy tuples are described in co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” filed on Dec. 23, 2005, commonly owned with the present application, and incorporated here by reference in its entirety.

Referring again to FIG. 4 and FIG. 5, once the relation tuple 455b is provided (block 502), a notification message is generated where the notification message includes at least a portion of the relation status information received in the first message (block 504). For example, a notification handler component 423 can be configured to generate the notification message including at least a portion of the received relation status information in response to updating the relation tuple 455b.

In one embodiment, the publication handler 426 can determine whether the message received includes a directed publish command that includes an identifier of a watcher component 255 (FIG. 2) to be notified of the updated relation status information. If a watcher 255 is identified, the publication handler 426 directs the notification handler 423 to generate and send the notification message to the identified watcher 255. Alternatively, or in addition, the subscription handler 424 can be notified of the updated information stored in the relation tuple 455b either by the relation status service 460 or by the tuple manager 428 depending on the embodiment. The subscription handler 424 can identify active subscriptions associated with at least one of the updated relation tuple 455b and a participant's tuple 455a. If an active subscription is detected, the subscription handler 424 directs the notification handler 423 to generate and send a notification message including at least a portion of the received relation status information to those watchers 255 actively subscribed.

In other embodiments, the notification handler 423 can be configured to receive messages including a fetch/poll request associated with at least one of the updated relation tuple 455b and the participant tuple 455a of a participant in the relation 324. The notification handler component 423 can use the message router component 422 to send the notification message over the network 110 to a watching or requesting entity using a presence protocol.

In an exemplary embodiment, so long as the relation 324 is active or alive, the relation status service 460 maintains the relation tuple 455b associated with the relation principal 324. Accordingly, when the relation status client 350 publishes updated relation status information relating to the relation 324, the relation status service 460 is configured to update the corresponding relation tuple 455b based on the updated information, and a notification message is generated and sent to watching entities. When the updated relation status information indicates that the relation 324 has been terminated, e.g., the meeting is completed, the transaction is closed, or a time period for responding to a message has expired, the relation status service 460 can be configured to remove the corresponding relation tuple 455b from the data store 440. A notification message including information associated with the termination of the relation is sent in some embodiments to a watcher 255 of at least one of the relation tuple 455b and a participant tuple 455a. The notification message is sent prior to, during, and/or after the removal of the corresponding relation tuple 455b depending on the embodiment.

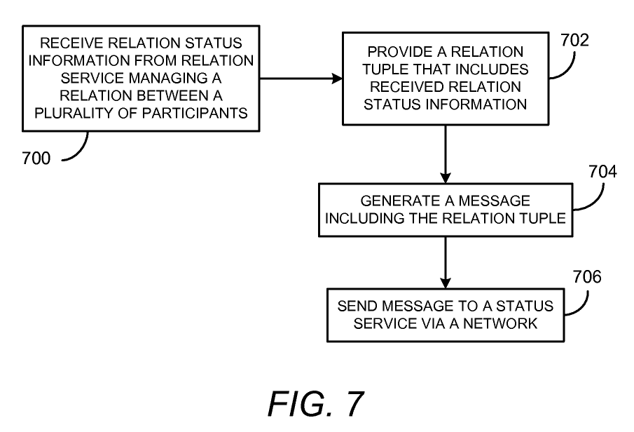

In another aspect of the subject matter disclosed herein, FIG. 7 is a flowchart of a method for providing status information relating to a relation from the perspective of the relation status client 350 according to another embodiment. Referring to FIG. 3 and FIG. 7, the method begins when relation status information is received from the relation service 320 that manages a relation 324 between a plurality of participants 230a, 230b (block 700). In one embodiment, the relation manager 322 in the relation service 320 can determine whether the status of a relation 324 changes by the occurrence of any event related to the relation 324. For example, for an IM service, a status changing event related to an IM session can include a message resulting in the creation of a session, a message indicating an active session and/or the current or last direction of communication, and a message ending the session either by an explicit indication from an IM client or by expiration of a timer. A detected change in status or other information comprising relation status information is transmitted to the relation status client 350 associated with the relation 324.

The relation status monitor 351 in the relation status client 350 provides, in an embodiment, an application programming interface (API) (not shown) to receive the relation status information from the relation manager 322. In one embodiment, the relation status information can include at least one of the status of the relation principal 324 and information identifying at least one of the plurality of the participants 230a, 230b.

Once the relation status information is received, a relation tuple is provided that includes the received relation status information (block 702). According to one embodiment, once the relation status monitor 351 receives the relation status information, it passes the information to a status user agent 354, such as a presence user agent (PUA), which invokes the relation presentity 352. The relation presentity 352, in an embodiment, then provides the relation tuple based on the relation status information. In one embodiment, the relation tuple includes a party element having the information identifying at least one of the plurality of participants, and a status element having the status of the relation.

In one embodiment, the relation presentity 352 generates a message including the relation tuple (block 704), and then sends the message, via the network 110, to the status service 420 (block 706) where the relation tuple 455b associated with the relation principal 324 is created and/or updated, as described earlier. In one embodiment, the message can also include a directed publish command that identifies at least one of the participants 230a, 230b to receive at least a portion of the relation status information.

According to one embodiment, the message is sent using a presence protocol layer 360 and a network protocol stack 380 over the network 110 to the status/presence service 420. Alternate embodiments use other protocols including proprietary protocols and messaging protocols. In this manner, a watcher component 255 watching at least one of the relation tuple 455b and a participant tuple 455a of a participant receives at least a portion of the relation status information.

According to one embodiment, the relation status client 350 can be a watching entity that watches status tuples 455 at the status service 420. In particular, the relation status client 350 can watch at least one of the relation tuple 455b and participant tuples 455a associated with the plurality of participants 230a, 230b. For example, the relation status client 350 can include a watch list monitor 353 that receives a request to watch a status tuple 455 from a user via a user interface (not shown) and/or from the relation service 320 via an API. In another embodiment, the request can originate from processing configuration data stored in persistent storage as a file and/or as one or more database records.

In one embodiment, the watch list monitor 353 passes the request to the status user agent 354, such as a watcher user agent (WUA), which invokes a watcher component 355. The watcher component 355 generates and sends a message including the request and information identifying the status tuple 455 to be watched to the status service 420 over the network 110. In one embodiment, the request can be a subscription request or a request to fetch the current status information associated with the identified status tuple 455. In this manner, the relation status client 350 can receive a notification message sent by the status service 420 via the network 110. The notification message can include information from at least one of the relation tuple 455b and the participant tuple 455a of a participant in the relation represented by the relation tuple 455b.

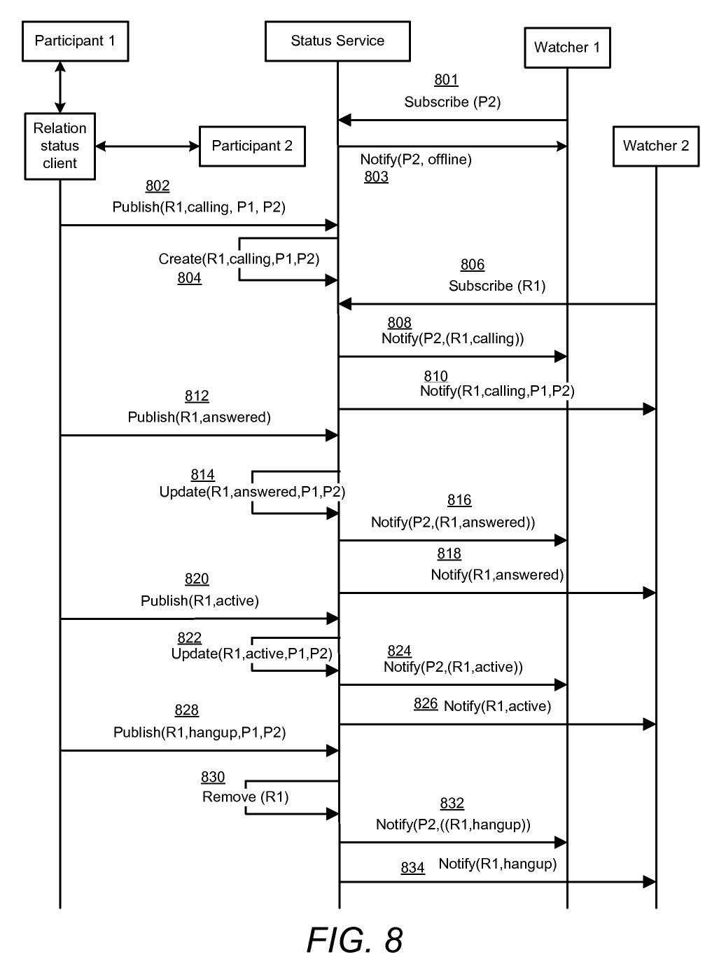

To illustrate further the aspects of one embodiment, FIG. 8 is a message flow diagram showing a process of providing status information relating to a relation between a plurality of participants according to one embodiment. The process is associated with a VoIP call between a first participant (P1) and a second participant (P2). As is shown, a first watcher (W1) subscribes to a presence tuple associated with P2 (block 801). Because P2 has not logged in with the status service, the status of P2 is “offline,” and a notify message including an identifier for P2 and its status is sent to W1 (block 803). In the meantime, P1 sends a message to a VoIP service to establish a call with P2. As a result, the VoIP service generates an instance of a relation status client, which publishes a message including an identifier for a relation tuple (R1), the status of the call (“calling”) and identifiers of P1 and P2 (referred to as “participant IDs”) to the status service (block 802).

The status service receives the message and the relation status service creates a relation tuple (R1), which includes the relation status, “calling,” and the participant IDs, P1 and P2 (block 804). A second watcher (W2) is subscribed to the relation tuple R1 (block 806). In one embodiment, the relation status service automatically subscribes W2 to the relation tuple R1 because W2 is associated with either the relation status client, P1 or P2.

The status service determines that W1 is watching, e.g., subscribed to, P2, a participant in the call associated with R1. Accordingly, the status service sends a notify message to W1 and W2. The notify messages can be different based on which status tuple the watcher is watching. For example, the notify message to W1 can include an identifier for P2 and a portion of the relation tuple R1, e.g., the tuple identifier and relation status (block 808), while the notify message to W2 can include the entire relation tuple R1 (block 810). Of significance is the fact that although P2 is offline, i.e., not logged in to the status service, a watcher of P2 receives status information associated with the VoIP call in which P2 is identified as a participant.

Each time the status of the VoIP call changes, e.g., P2 answers the call and the call becomes active, the relation status client publishes status information relating to the call (blocks 812, 820). Each time the status service receives new status information, it updates R1 (blocks 814, 822) and sends notification messages to W1 (blocks 816, 824) and to W2 (blocks 818, 826). Eventually, the relation status client publishes a new status of the call that indicates that the call has been terminated, e.g., “hang up,” (block 828). The status service receives the new status information and determines that the call is terminated based on the status, and removes R1 from storage (block 830). The status service then sends notification messages to W1 (block 832) and to W2 (block 834).

According to aspects of the methods and systems described above, relation tuples 455b are used to provide status information relating to a relation between a plurality of participants 230a, 230b. By providing relation status information, as well as a participant's presence information, a watching entity can better determine the participant's true status. Moreover, by providing a relation tuple 455b to represent the relation, as opposed to augmenting the participant's tuple 455a with relation information, relation specific information can be maintained and updated in substantially real-time without affecting the participant's presence tuple and without requiring publishing to the participant's presence tuple by a status agent that is not under the control of the owning principal. For example, rather than tracking phone call activity in the presence tuples of each of the participants, a single relation tuple representing the call enables tracking of the call without requiring format changes to participant tuples.

In one embodiment described briefly above, the status service 420 can be dedicated to relations 324 and relation tuples 455b. In this model, all status tuples 455 are relation tuples 455b. Accordingly, entities exist only as participants in a relation. An entity, e.g. a person or a device, is associated with a status that is made up of the status of at least a portion of the relations in which the entity is included. In one embodiment, a relation tuple 455b can have a friend's list just as conventional participant tuples 455a have friend's lists. In another embodiment, a relation tuple 455b can represent a relation between a user and the status service 420 that creates and manages the relation tuple 455b. In this embodiment, the relation tuple 455b can serve as a type of presence tuple, thus providing an equivalent to current presence systems along with the new relation information.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing status information relating to a relation between a plurality of participants, the method comprising:
receiving a first message from an agent associated with a relation principal for a relation between a plurality of participants, the message including relation status information of the relation;
providing a relation tuple associated with the relation principal for the relation, the relation tuple including a party element having information identifying at least one of the plurality of participants in the relation and a status element having a status of the relation; and
generating a notification message including at least a portion of the received relation status information in response to providing the relation tuple.

2. The method of claim 1 further including sending the notification message to at least one of a watcher identified in the message from the agent associated with the relation principal, and a watcher of at least one of the relation tuple and a status tuple of a participant of the plurality of participants.

3. The method of claim 2 wherein at least one of receiving the message and sending the notification message comprises using a presence service and a presence protocol to at least one of receive the message and send the notification message.

4. The method of claim 2 wherein in response to providing the relation tuple, the method further comprises:
creating automatically a subscription list for the relation tuple; and
placing information identifying a watcher component associated with at least one of the plurality of participants identified by the relation tuple in the subscription list.

5. The method of claim 2 wherein in response to providing the relation tuple, the method further comprises automatically updating the status tuple of the participant of the plurality of participants.

6. The method of claim 1 further including:
receiving a second message from the agent associated with a relation principal, the second message including updated relation status information of the relation;
updating the relation tuple based on the updated relation status; and
generating a notification message including at least a portion of the updated relation status information.

7. The method of claim 1 wherein the agent associated with the relation principal includes a presentity of the relation tuple.

8. The method of claim 1 further comprising storing the relation tuple in a data store for a duration of the relation between the plurality of participants.

9. The method of claim 8 further comprising removing the relation tuple from the data store when the relation between the plurality of participants is terminated.

10. A method for providing status information relating to a relation between a plurality of participants, the method comprising:
receiving relation status information from a relation service managing a relation between a plurality of participants;
providing a relation tuple that includes the relation status information, the relation tuple comprising a party element having information identifying at least one of the plurality of participants in the relation and a status element having a status of the relation;
generating a message including the relation tuple; and
sending the message to a status service via a network such that a watcher component watching at least one of the relation tuple and a status tuple of a participant of the plurality of participants receives at least a portion of the relation status information included in the relation tuple.

11. The method of claim 10 wherein generating the message includes:
invoking a presentity associated with the relation tuple to create the message including the relation status information.

12. The method of claim 10 wherein the status service is included in a presence service and sending the relation tuple comprises using a presence protocol.

13. The method of claim 10 further comprising:
receiving an indication to watch a status tuple of at least one participant identified in the relation tuple; and
using a watcher component to watch the status tuple.

14. The method of claim 13 wherein receiving the indication to watch includes receiving the indication via at least one of a user interface, an application programming interface, and processing configuration data stored in a data store.

15. A system for providing status information relating to a relation between a plurality of participants, the system comprising:
a relation status service component configured for receiving a first message from an agent associated with a relation principal for a relation between a plurality of participants, the message including relation status information of the relation, and for providing a relation tuple associated with the relation principal for the relation, the relation tuple including a party element having information identifying at least one of the plurality of participants in the relation and a status element having a status of the relation; and
a notification handler component configured for generating a notification message including at least a portion of the received relation status information in response to providing the relation tuple.

16. The system of claim 15 wherein the notification handler component is further configured for sending the notification message to at least one of a watcher identified in the message received from the agent associated with the relation principal, and a watcher component watching at least one of the relation tuple and a status tuple of a participant of the plurality of participants.

17. The system of claim 16 wherein at least one of the relation status service component and the notification handler component is further configured to receive the message and to send the notification message, respectively, using a presence protocol.

18. The system of claim 16 further comprising a subscription handler component configured for creating automatically a subscription list for the relation tuple and placing information identifying a watcher component associated with at least one of the plurality of participants identified by the relation tuple in the subscription list in response to the providing of the relation tuple.

19. The system of claim 16 wherein the relation status service component is further configured for automatically updating the status tuple of the participant of the plurality of participants when the relation tuple is provided.

20. The system of claim 15 wherein the relation status service is further configured for receiving a second message from the agent associated with a relation principal, the second message including updated relation status information of the relation, and for updating the relation tuple based on the updated relation status.

21. The system of claim 15 wherein the agent associated with the relation principal includes a presentity of the relation tuple.

22. The system of claim 15 further comprising a data store for storing data comprising status tuples and wherein the relation status service component is further configured for storing the relation tuple in the data store for a duration of the relation between the plurality of participants.

23. The system of claim 22 wherein the relation status service component is further configured for removing the relation tuple from the data store when the agent associated with the relation principal terminates the relation between the plurality of participants.

24. The system of claim 22 wherein each status tuple stored in the data store is a relation tuple.

25. The system of claim 15 further comprising a presence service and a communication interface configured to send and receive data to and from a plurality of presence clients associated with a plurality of relation principals via a network.

26. A system for providing status information relating to a relation between a plurality of participants, the system comprising:
a relation service configured for managing a relation between a plurality of participants and for providing a relation principal associated with the relation; and
a relation status client component associated with the relation principal and configured for receiving relation status information from the relation service, for providing a relation tuple that includes relation status information, the relation tuple comprising a party element having information identifying at least one of the plurality of participants in the relation and a status element having a status of the relation, for generating a message including the relation tuple, and for sending the message to a status service via a network such that a watcher component watching at least one of the relation tuple and a status tuple of a participant of the plurality of participants receives at least a portion of relation status information included in the relation tuple.

27. The system of claim 26 wherein the relation status client component is configured for invoking a relation presentity to create the message including the relation status information.

28. The system of claim 26 wherein the relation status client component is configured for using a presence protocol to send the relation tuple to the relation status service.

29. The system of claim 26 wherein the relation status client component is configured for receiving an indication to watch a status tuple of at least one participant identified in the relation tuple, and for using a watcher component to watch the status tuple.

30. The system of claim 29 wherein the relation status client is configured for receiving the indication via at least one of a user interface, an application programming interface, and processing configuration data stored in a data store.

31. A computer readable medium containing a computer program, executable by a machine, for providing status information relating to a relation between a plurality of participants, the computer program comprising executable instructions for:
receiving a first message from an agent associated with a relation principal for a relation between a plurality of participants, the message including relation status information of the relation;
providing a relation tuple associated with the relation principal for the relation, the relation tuple including a party element having information identifying at least one of the plurality of participants in the relation and a status element having a status of the relation; and
generating a notification message including at least a portion of the received relation status information in response to providing the relation tuple.

32. The computer readable medium of claim 31 wherein the program further includes instructions for:
sending the notification message to at least one of a watcher identified in the message from the agent associated with the relation principal, and a watcher of at least one of the relation tuple and a status tuple of a participant of the plurality of participants.

33. The computer readable medium of claim 32 wherein in response to providing the relation tuple, the program further includes instructions for automatically updating the status tuple of the participant of the plurality of participants.

34. The computer readable medium of claim 31 wherein the program further includes instructions for storing the relation tuple in a data store for a duration of the relation between the plurality of participants and for removing the relation tuple from the data store when the agent associated with the relation principal terminates the relation between the plurality of participants.

35. A computer readable medium containing a computer program, executable by a machine, for providing status information relating to a relation between a plurality of participants, the computer program comprising executable instructions for:
receiving relation status information from a relation service managing a relation between a plurality of participants;
providing a relation tuple that includes the relation status information, the relation tuple comprising a party element having information identifying at least one of the plurality of participants in the relation and a status element having a status of the relation;
generating a message including the relation tuple; and
sending the message to a status service via a network such that a watcher component watching at least one of the relation tuple and a status tuple of a participant of the plurality of participants receives at least a portion of the relation status information included in the relation tuple.

36. The computer readable medium of claim 35 wherein the program further includes instructions for invoking a presentity associated with the relation tuple to create the message including the relation status information.
